(19) United States
(12) Patent Application Publication
(10) Pub. No.: US 2012/0047703 A1
(43) Pub. Date: Mar. 1, 2012

(54) Tie Rod Puller Tool

(75) Inventors: Scotty R. Kurtz, Clarinda, IA (US); Dalles D. Beery, Maryville, MO (US)

(73) Assignee: Lisle Corporation, Clarinda, IA (US)

(21) Appl. No.: 12/872,519

(22) Filed: Aug. 31, 2010

(51) Int. Cl. B25B 27/14; B23P 11/00

(52) U.S. Cl. 29/426.5; 29/270; 29/254

(57) ABSTRACT

A tool for removal of a motor vehicle tie rod from a knuckle assembly includes first and second spaced planar plates. The first plate has spaced tines that fit around the axial connecting pin or shaft located at one end of a tie rod and engaging a knuckle assembly. A stem projecting axially from the second plate enables the tool to be driven axially to cause disengagement of the tie rod from the knuckle assembly.

### BACKGROUND OF THE INVENTION

In a principal aspect the present invention relates to a tool uniquely capable of facilitating the disengagement of a tie rod from the knuckle assembly in steering gear for a vehicle.

Motor vehicles include steering gear which comprise a complex arrangement of various connected mechanical parts. Typically, steering gear will include a tie rod which connects a steering mechanism with wheels pivotally mounted to effect turning movement by the vehicle. There are a myriad of such steering gear assemblies including designs for tie rods and their mechanical interaction with other component parts of steering gear. A typical arrangement provides for a tie rod having a tie rod end section rotationally joined or connected to a knuckle assembly. A general construction of such an assembly includes various protective features for the knuckle assembly. For example, a flexible boot may be incorporated in the construction. Such a boot protects the joint or juncture between tie rod and knuckle assembly. Repair of such steering gear may require disassembly of such component parts.

Thus, when repairing the steering system or gear of a vehicle, it may be necessary to separate the end of the tie rod from the knuckle assembly. In order to effect such a repair, it may be necessary to remove the boot from the knuckle assembly and then release or disengage the tie rod connection from that knuckle assembly.

It has been discovered that with certain tie rod/knuckle assemblies, removal of the tie rod connection from the knuckle assembly requires great care in order to avoid damage to either the knuckle assembly or the tie rod or the protective boot. An example of such a circumstance is associated with various Ford vehicles. That is, typically to disengage the tie rod from the knuckle assembly mechanics may use a hammer or some other tool to impact the tie rod and thus disengage it from the knuckle assembly. However, such a protocol may cause damage to both the tie rod and the knuckle assembly, or at least one the component parts resulting in a delay in mechanical repair and, of course, adding unnecessary cost to the repair. Thus, there has developed a need for a tool or a protocol to avoid such damage to a tie rod and knuckle assembly during repair of a steering system.

### SUMMARY OF THE INVENTION

Briefly, the present invention comprises a specialty automotive tool which may be utilized to disengage a connecting axial shaft projecting from the end of a tie rod and engaged with a knuckle assembly of steering gear. The tool is comprised of first and second spaced plates which fit over the end of the tie rod. One of the plates is formed in the shape of a fork having generally parallel, shaped, spaced tines or prongs which are designed to fit around the shaft projecting from the end of the tie rod. The prongs or tines which project each include leading edge wedge sections which are designed to guide the prongs into engagement with the underside of the end of the tie rod in a manner which will avoid damage to the attached knuckle assembly and the boot which is typically part of the knuckle assembly. Thus, the spaced prongs or tines associated with one of the plates is positioned on the bottom side of the end of tie rod from which the connecting axial shaft projects and the other or second spaced plate fits over the top of the tie rod. The upper and lower plates are linked together by connecting side members or plates to thereby form a cage which fits over the end of the tie rod. A mechanical stem projects from the upper or second plate and is typically tilted slightly in the direction of the prongs of the lower or first plate. A slide hammer may be attached to the upper stem and may be engaged to provide a driving force that is imparted to the tie rod to thereby effect removal of the axial tie rod shaft from the knuckle assembly.

To disengage a tie rod by removal thereof from the knuckle assembly, the first and second spaced plates are fitted around the axial shaft at the accessible end of the tie rod. A slide hammer attached to the stem projecting from the upper or second plate of the tool can then be driven in a manner which will release or disengage the axial shaft projecting from the end of the tie rod from the knuckle assembly.

Thus, it is an object of the invention to provide an improved tool for facilitating removal of a tie rod from a knuckle assembly.

A further object of the invention is to provide a tool which can be easily engaged with the end of a tie rod attached to a knuckle assembly without damaging the knuckle assembly or the connection between the knuckle assembly and the tie rod.

Another object of the invention is to provide an automobile repair tool useful for the removal or disconnection of a tie rod from a knuckle assembly which is easy to use, inexpensive and which facilitates timely, safe removal of a tie rod from a knuckle assembly.

Yet a further object of the invention is to provide a tool which enables application of force to a tie rod to effect removal thereof from a knuckle assembly while providing minimal likelihood that the force imparted by the tool will cause damage to the tie rod or the knuckle assembly.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is a side elevation of the tool of the invention;

FIG. 2 is top plan view of the tool of FIG. 1;

FIG. 3 is a sectional view taken along the line 3-3 of FIG. 2;

FIG. 4 is an isometric view of the tool of FIG. 1;

FIG. 5 is another isometric view of the tool of FIG. 1 as positioned on a tie rod that is to be removed from a knuckle assembly;

FIG. 6 is an isometric view illustrating the engagement of the tool with the end of a tie rod that is affixed to or attached to a knuckle assembly; and

FIG. 7 is another isometric view of the tool of the invention engaged with the end of a tie rod depicting the end of the tie rod as disengaged from a knuckle assembly.

### DESCRIPTION OF AN EMBODIMENT OF THE INVENTION

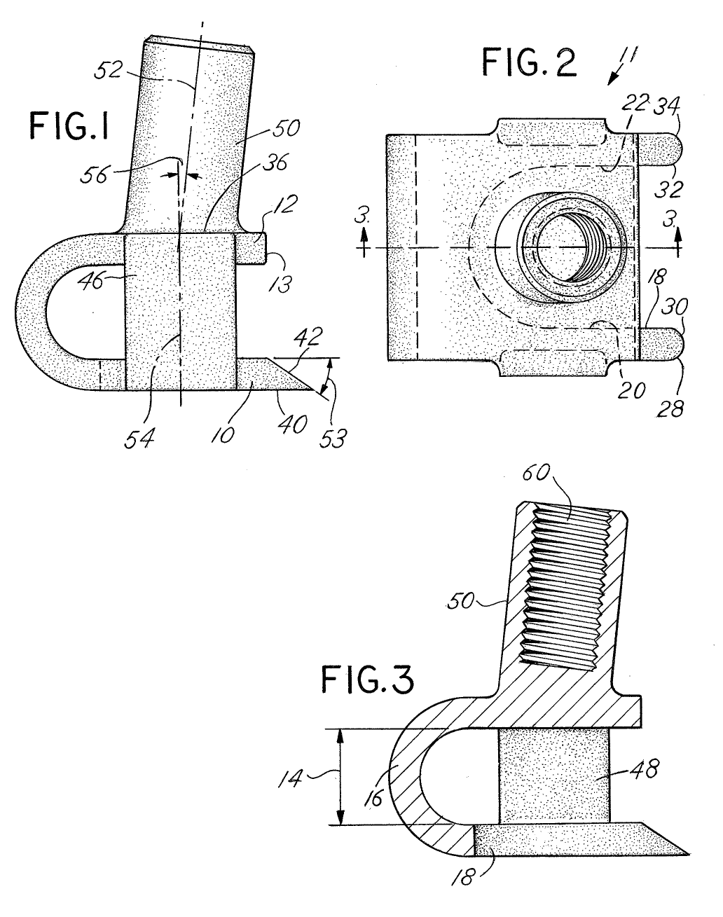

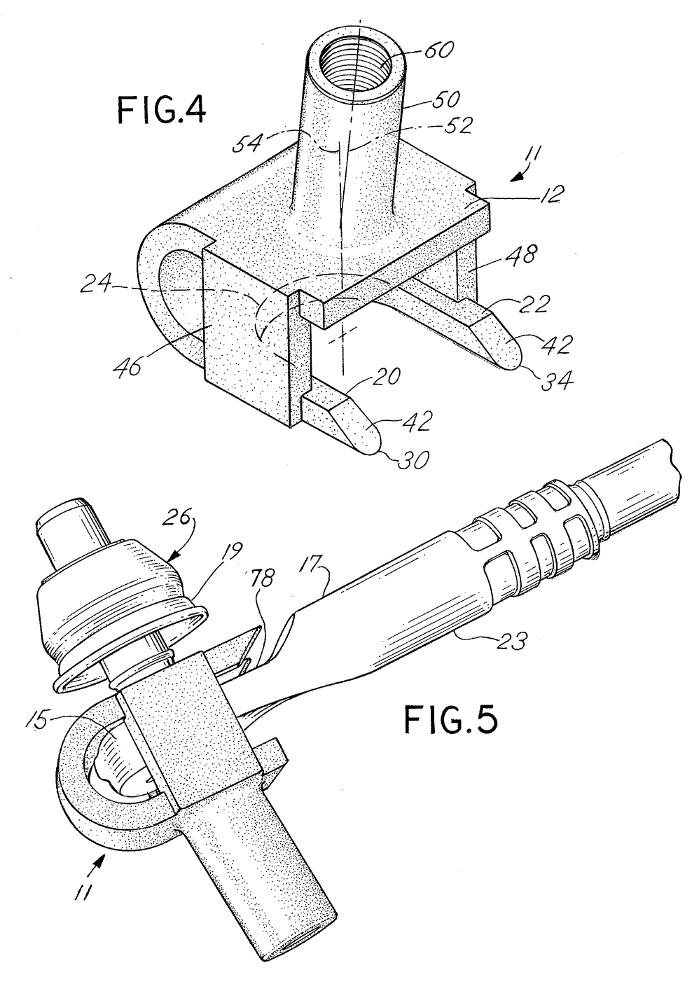

Referring to FIGS. 1-4, there is depicted the tool of the invention in various views. The tool 11 is comprised of a first or lower planar plate 10 which is spaced uniformly axially from an upper or second planar plate 12. The axial spacing 14 of the flat, planar inside surfaces of the plates 10 and 12 is associated with and is at least slightly greater than the thickness of the end section 15 of a tie rod 17 as will be discussed hereinafter with respect to the remaining figures. The first planar plate 10 and the second planar plate 12 are generally flat, planar, spaced plates and, in the embodiment depicted, may be interconnected by a U-shaped crown 16. That is, the first plate 10 and the second plate 12 may be formed from a sheet of metal stock by cutting the flat, planar piece of the stock and then bending it to the configuration depicted in FIGS. 1-4. Plates 10, 12 are parallel and spaced from one another by a dimension slightly greater than the traverse dimension or thickness of end section 15 of a tie rod 17.

The first planar plate 10 includes a longitudinal slot 18 which is defined by a first prong or tine 20 and a spaced, generally parallel, second prong or tine 22. The tines 20 and 22 are spaced laterally from one another by a dimension adequate for receipt therebetween of an axial shaft 23 projecting transversely from the end section 15 of the tie rod 17, as depicted in greater detail in the remaining FIGS. 5-7. The slot 18 may be configured with an arcuate interior curved section 24 which smoothly connects with the interior sides or lateral surfaces of the respective prongs 20 and 22.

The respective prongs 20 and 22 are generally straight with a uniform width and include substantially identical forward wedge sections 28 and 32, respectively, with a leading edge 30 and 34, respectively. The leading edges 30 and 34 are aligned transversely with respect to the direction of the tines or prongs 20 and 22. The prongs 20, 22 extend longitudinally beyond transverse edge 13 of upper plate 12.

The end wedge sections 28 and 32 are, as depicted in FIGS. 1 and 3, formed in a manner wherein the included angle 53 between the outside flat planar surface 40 and inclined surface 42 of the wedge sections 28 and 32 is in the range of 25-40° and most generally in the range of 30-35° included angle. The opposite sides of the first plate 10 and second plate 12 are joined together by connecting side or lateral connecting plates or sections, such as connecting sections 46 and 48. Thus, the plates 10, 12 and connecting sections 46 and 48 form an enclosure or cage which is designed to fit over the end section 15 of a tie rod 17, again as illustrated in FIGS. 5-7.

The outer surface 36 of the top plate 12 includes a projecting stem 50 which is cylindrical in configuration in the embodiment depicted and includes a center line axis 52 which is generally aligned with and intersects a vertical axis 54 to the flat planar outer surface 36. The stem 50 is inclined in the direction of the projecting tines or prongs 20 and 22 in an angular amount of 3° to 10° and, most generally, in an angular amount of at least about 5° to 7°. This is represented by the included angle 56 in FIG. 1.

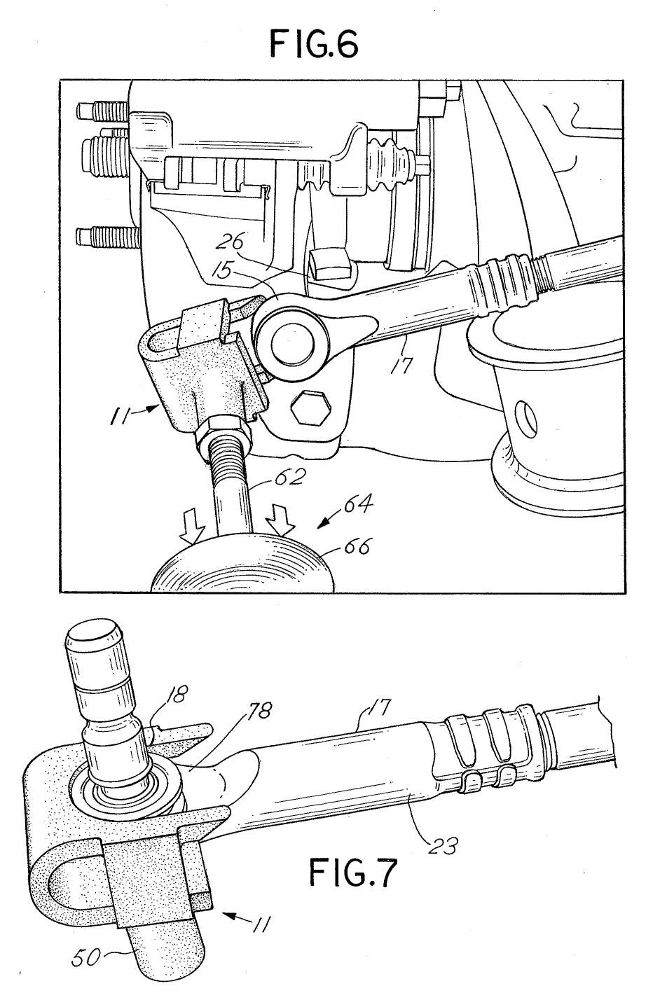

In the embodiment depicted, the stem 50 includes a threaded internal passage or counterbore 60 for receipt of a threaded rod 62 of a slide hammer 64 as shown in FIG. 6. Thus, actuation of slide 66 of the slide hammer 64 in the axial direction of the rod 62 will effectively drive the stem 50 and thus the tool to separate the end section 15 of tie rod 17 from a knuckle assembly 26, again as depicted in FIGS. 5-7.

Referring to FIGS. 5-7, the tool 11 is depicted in position for engaging the end section 15 of a tie rod 17. The end section 15 is generally cylindrical or disc shaped and includes a lower engagement flange or shoulder 78, a thickness or axial dimension and a width or lateral or side to side dimension. The leading edge surfaces 30 and 34 of tool 11 fit in the juncture between the end section 15 of the tie rod 17 against the shoulder 78 and the top of a knuckle assembly 26. The knuckle assembly 26 includes a boot 19. It may be necessary to loosen the boot 19 in order to permit the lower plate 10 to slide between the end 15 of the tie rod 17 and the knuckle assembly 26. The plates 10, 12 are generally uniformly spaced.

FIG. 5 depicts the insertion of the tool 11 over the end 15 of the tie rod 17 in a manner which enables actuation of slide hammer 64 on rod 62 in FIG. 6 that is attached to the stem 50. The slide hammer 64 may then be operated to effect release of the tie rod 17 from the knuckle assembly 26. FIG. 7 depicts the separated end 15 of the tie rod 17 and the projecting shaft 23 of tie rod 26 that has been removed from a knuckle assembly 26.

Thus, FIGS. 5-7 illustrate the sequence of operation appropriate to effect the removal of the tie rod 17 from the knuckle assembly 26 including the positioning of the tool 11 on the end section 15 of the tie rod 17 and the subsequent actuation of a slide hammer 64 or similar tool in combination with the tool 11 to effect a force which removes the engagement of the tie rod 17 and, more particularly, the shaft 23 associated with the tie rod 17 that extends axially therefrom to engage the knuckle assembly 26.

While there has been set forth an embodiment of the invention, it is to be understood that the invention is to be limited only by the following claims and equivalents thereof. For example, the spaced planar plates 10, 12 may be fabricated by casting or forging or comprised of, or fabricated from tubular material which has been shaped or formed in a configuration generally like that of the tool 11 depicted in FIGS. 1-4. Further, the operation of the stem 50 to effect driving actuation may be provided by other means projecting from the upper or top plate 12. Preferably, the stern 50 projecting from the upper, top plate 12 is inclined in the manner described to facilitate the placement of the tool 11 on the end of the tie rod 17. The U-shaped crown 16 of the tool 11 may be replaced by a flat or curved plate welded into position. Various other constructions which result in the general configuration of the tool with the spaced first and second planar plates 10, 12 and the prongs or tines 20, 22 having a configuration as described, may provide the benefits and utility of the embodiment disclosed. Further, the tool 11 may be utilized to separate mechanical parts other than a tie rod from a knuckle assembly. Therefore, the invention is to be limited only by the following claims and equivalents thereof.

What is claimed is:

1. A tool for disengaging a vehicle tie rod from a knuckle assembly of steering gear wherein said tie rod includes an end section with a knuckle assembly connection including a transversely, axially projecting shaft for engaging said associated knuckle assembly, said tie rod fitting including a shoulder juxtaposed to said knuckle assembly, said tie rod having an end section with an axial dimension defining a thickness and a transverse dimension defining a width, said tool comprising:
a first planar fork shaped plate with a slot defined by first and second generally parallel, spaced, longitudinally projecting tines, said tines each including a wedge shaped leading edge section, each said leading edge section including a leading edge transverse to the parallel tines, said tines laterally spaced by a dimension greater than the diameter of the axially projecting shaft, each tine including an outer side and an inner side;
a second generally planar mounting plate generally parallel to and spaced from the first planar plate by a dimension greater than the axial dimension of said end section, said second mounting plate including lateral sides generally aligned with the outer sides of the first and second tines, said second mounting plate joined to the first mounting plate by connecting members joining each said respective lateral side to a said respective outer side; and
said second mounting plate further including a top side with a drive stem projecting outwardly therefrom along a stem axis forming an angle with the second mounting plate.

2. The tool of claim 1 wherein the first and second mounting plate connecting members are spaced a distance greater than the transverse dimension of said tie rod fitting.

3. The tool of claim 1 wherein the first and second plates are comprised of a unitary member including a crown connection between said first and second plates, said crown connection connecting the first and second plates.

4. The tool of claim 1 wherein the drive stem projects at an angle in the range of about 4° to 10°.

5. The tool of claim 4 wherein the angle is in the range of about 5° to 7°.

6. The tool of claim 1 further including a threaded counterbore in said drive stem axially aligned with said drive stem.

7. The tool of claim 6 wherein a slide hammer shaft and slide hammer are affixed to said drive stem.

8. The tool of claim 1 wherein the leading edge section of the first plate includes a generally flat planar bottom side or outer side and an inclined face from the leading edge of each tine in the range of about 25° to 40°.

9. The tool of claim 8 wherein the angle formed by the outer bottom side of the first plate and the inclined surface of the wedge shaped leading edge is about 35°±5°.

10. A method for removal of a vehicle tie rod from a knuckle assembly comprising the steps of positioning the tool of claim 1 around the end section of the tie rod by directing movement of the tines around the axially projecting shaft and against the underside of the tie rod end section; and
axially driving the tie rod in the direction of the drive stem along the stem axis.
